(19) United States
(12) Patent Application Publication
(10) Pub. No.: US 2010/0022702 A1
(43) Pub. Date: Jan. 28, 2010

(54) THERMALLY STABLE FLUOROPOLYMERS

(76) Inventors: Lisa P. Chen, St. Paul, MN (US); Harald Kaspar, Burgkirchen (DE); Tilman C. Zipplies, Burghausen (DE); Barbara Ann Yoder, Hudson, WI (US); Jeffrey G. Linert, Woodbury, MN (US)

Correspondence Address: 3M INNOVATIVE PROPERTIES COMPANY, PO BOX 33427, ST. PAUL, MN, 55133-3427, US

(21) Appl. No.: 12/515,419

(22) PCT Filed: Dec. 10, 2007
(86) PCT No.: PCT/US07/86900

§ 371 Date: May 19, 2009

Related U.S. Application Data
(60) Provisional application No. 60/869,654, filed on Dec. 12, 2006.

(51) Int. Cl. C08L 27/12; C08F 14/18; C08F 2/22

(52) U.S. Cl. 524/544; 526/250; 526/209

(57) ABSTRACT

A fluorinated polymer composition, an article made with the fluorinated polymer composition and a method of making the fluorinated polymer are provided. The method comprises a partially fluorinated polymer which has carboxylic or carboxylate end groups and forming a potassium salt with the end groups of the fluorinated polymer through ion exchange. The resulting partially fluorinated polymers demonstrate high thermal stability without the addition of thermal stabilizers.

This application claims priority to U.S. Provisional Patent Application No. 60/869,654, filed Dec. 12, 2006, the disclosure of which is incorporated by reference herein in its entirety.

### FIELD OF THE INVENTION

The present invention relates to partially fluorinated polymers, such as ethylene-tetrafluoroethylene copolymer (ETFE), that demonstrate high thermal stability without the addition of thermal stabilizers.

### BACKGROUND OF THE INVENTION

Thermal stabilizers have conventionally been used to prevent degradation of fluoropolymers when the fluoropolymers are subsequently processed or exposed to elevated temperatures for an extended period of time. The stabilizers are traditionally heavy metal powders, oxides, nitrates, halides, or complexes thereof. In particular, copper compounds are one example of conventionally recognized thermal stabilizers. The copper compounds are used in powder form and are admixed or blended with the fluoropolymers, such as ethylene-tetrafluoroethylene (ETFE) copolymers. Alternatively, an aqueous slurry or an organic solvent slurry of a fluoropolymer and copper compound may be utilized to create the blend. In either case, an additional manufacturing step is required to incorporate the thermal stabilizer.

Often times the inclusion of specific additives, such as thermal stabilizers to impart desired thermal resistance, can adversely affect other physical or chemical characteristics of the fluoropolymer. Additionally, some additives may be considered potentially harmful to the environment. Therefore, it would be desirable to produce a fluoropolymer possessing the desired physical characteristics without the need for additive compositions, such as thermal stabilizers.

Currently, conventionally employed polymerization methods include solution polymerization, solvent slurry polymerization and especially aqueous emulsion polymerization. Aqueous emulsion polymerization has been generally preferred for the production of fluoropolymers because the process is more environmentally friendly than solution polymerization in organic solvents and furthermore allows for easy recovery of the resulting polymer. However, for certain applications, the fluoropolymers produced via the aqueous emulsion polymerization process may have somewhat inferior properties relative to similar polymers produced via solution polymerization. For example, copolymers of ethylene and tetrafluoroethylene (ETFE) produced by solution polymerization generally have a better heat resistance than similar polymers produced via aqueous emulsion polymerization.

It would be desirable to improve the thermal stability of fluoropolymers made by aqueous emulsion polymerization. It is in particular, desirable to produce partially fluorinated polymers such as ETFE that can produce smooth bubble free powder coatings at temperatures in the range of 300° C.

### SUMMARY OF THE INVENTION

Partially fluorinated polymers are known to have good thermal, chemical, electrical, and mechanical properties, but are also known to thermally degrade when exposed to temperatures above their melting temperature for extended periods of time. Embrittlement and foaming are often observed after exposure to elevated temperatures especially in an air atmosphere, and the molecular weight as measured by melt flow index (MFI) may either increase as a result of loss of molecular weight or decrease due to molecular build-up. The less than desired thermal properties may also be attributed to residues from certain types of initiators used in the aqueous emulsion polymerization.

According to the present invention, enhanced thermal stability of partially fluorinated polymers is achieved by substantially replacing the cations in the aqueous dispersion of fluoropolymers, such as ETFE, with potassium ions and working up the dispersion to obtain solid powder or agglomerate. The replacement of cations by potassium ions can be achieved by conventional ion exchange technology and most preferably by passing the dispersion through an ion exchange column that has been regenerated into the potassium form. Other partially fluorinated thermoplastics such as terpolymers of tetrafluoroethylene, hexafluoropropylene, and vinylidene fluoride (THV); and hexafluoropropylene, tetrafluoroethylene, and ethylene (HTE) can also be made according to this invention for improved stability against oxidative or thermal degradation.

In another embodiment of the invention, the replacement of the cations in the fluoropolymer dispersion with potassium ions results in a partially fluorinated polymer that possesses the desired thermal stability properties as measured by, for example, a limited change in MFI value during post thermal treatment.

The fluoropolymers produced according to this invention can be used for melt processing such as extrusion, compression or injection molding and are especially useful for applications where the polymer is subjected to high temperatures for extended periods of time in the presence of air. Applications may include wire insulation, film or sheet extrusion, or rotomolding and tank lining. The invention is especially useful for producing fluoropolymers for surface coatings such as powder coatings. In preferred partially fluorinated polymers such as ETFE powder coating applications, the metal substrate may or may not be preheated to temperatures between 300° C.-320° C. The substrate is electrostatically coated with ETFE powder and then heated in an air circulating oven for up to 40 minutes allowing the powder particles to melt, coalesce and form a uniform film on the substrate. Because the thickness of the coating is generally limited to approximately 100 microns after each application, multiple applications are required to achieve the ultimate desired coating thickness. This results in repeated exposure of the ETFE coating to temperatures well above the melting point for long periods of time. ETFE as well as other partially fluorinated polymers produced according to this invention remain thermally stable throughout this process without the need of thermal stabilizers. The resulting coatings do not exhibit sagging or cracking. From a manufacturing perspective, the fluoropolymers do not require the additional blending step for adding thermal stabilizers. Fluoropolymers, i.e. polymers having a fluorinated backbone, long have been known and have been used in a variety of applications because of several desirable properties such as heat resistance, chemical resistance, weatherability, and UV-stability, among others.

### DETAILED DESCRIPTION OF THE INVENTION

Aqueous dispersions of partially fluorinated polymers can be prepared in a manner known to those skilled in the art. The polymerization can, for example, be initiated by means of a potassium permanganate system. This results in manganese (II) ions in the dispersion which are generally removed by passing the dispersion through a column containing a commercial strongly acidic ion exchanger to substantially replace the cations in the dispersion with hydrogen ions. However, this method produces ETFE that has a limited thermal stability.

In the present invention partially fluorinated polymers with excellent thermal stability are obtained by substantially replacing the cations in the aqueous dispersion resulting from the polymerization with potassium ions and then working up the polymer to obtain solid agglomerate. This process includes ion exchanging the dispersion using cation exchange resin regenerated to the potassium form, coagulating the latex mechanically (preferably without the use of acids), agglomerating the polymer, filtering and washing the agglomerate with or without the addition of acid, and drying the agglomerate. The work up procedure is described in U.S. Pat. No. 5,463,021. In the case of modified ETFE, the agglomerate produced according to this invention is thermally stable when exposed to 300° C. for over 3 hours in an air atmosphere as measured by change in MFI.

Generally, the aqueous emulsion polymerization process is carried out in the presence of a fluorinated surfactant, typically a non-telogenic fluorinated surfactant. The fluorinated surfactant is generally used to ensure the stabilization of the polymer particles formed. Suitable fluorinated surfactants include any fluorinated surfactant commonly employed in aqueous emulsion polymerization.

Particularly preferred fluorinated surfactants are those that correspond to the general formula:

Y—R_{f}—Z—M (III)

wherein Y represents hydrogen, Cl or F; R_{f} represents a linear or branched perfluorinated alkylene having 4 to 10 carbon atoms; Z represents COO⁻ or SO₃⁻and M represents an alkali metal ion or an ammonium ion. Most preferred fluorinated surfactants for use in this invention are the ammonium salts of perfluorooctanoic acid and perfluorooctane sulphonic acid. Mixtures of fluorinated surfactants can be used.

Alternatively, an aqueous emulsion polymerization may also be carried out in the presence of a fluorinated surfactant selected from formula (I):

[R_{f}O—L—CO₂⁻]ᵢXⁱ⁺ (I)

wherein R_{f} is selected from a partially fluorinated alkyl group, a fully fluorinated alkyl group, a partially fluorinated alkyl group that is interrupted with one or more oxygen atoms, and a fully fluorinated alkyl group that is interrupted with one or more oxygen atoms; L is selected from a partially fluorinated alkylene group, a fully fluorinated alkylene group, a partially fluorinated alkylene group that is interrupted with one or more oxygen atoms, and a fully fluorinated alkylene group that is interrupted with one or more oxygen atoms and may be linear or branched; Xⁱ⁺ represents a cation having the valence i; and i is 1, 2, or 3. Surfactants meeting formula (I) can include CF₃O(CF₂)₃OCHFCF₂COOA, CF₃O(CF₂)₃OCF₂COOA, CF₃CF₂OC₂F₄OCF₂COOA, CHF₂CF₂OC₂F₄OCF₂COOA, CF₃(CF₂)₃OCF₂COOA, and CHF₂(CF₂)₃OCF₂COOA, where A is a cation (e.g., H⁺, NH₄⁺, K⁺, Na⁺, and Li⁺). Additional surfactants meeting formula (I) may be found in U.S. patent application Ser. No. 11/457,239 and PCT publications WO 2007/120346, WO 2007/062059, WO 2007/011633, and WO 2007/011631.

The aqueous emulsion polymerization process is generally conducted in the commonly known manner. The reactor vessel is typically a pressurizable vessel capable of withstanding the internal pressures during the polymerization reaction. Typically, the reaction vessel will include a mechanical agitator, which will produce thorough mixing of the reactor contents and a heat exchange system.

Any quantity of the monomer(s) specified under the present invention may be charged to the reactor vessel. The monomers may be charged batchwise or in a continuous or semicontinuous manner. By semi-continuous, it is meant that a plurality of batches of the monomer are charged to the vessel during the course of the polymerization. The independent rate at which the monomers are added to the vessel will depend on the consumption rate of the particular monomer with time. Preferably, the rate of addition of monomer will equal the rate of consumption of monomer, i.e. conversion of monomer into polymer.

The reaction vessel is charged with water, the amounts of which are not critical. To the aqueous phase there is generally also added the fluorinated surfactant which is typically used in the amount of 0.01% by weight to 1% by weight. A conventional chain transfer agent is typically charged to the reaction vessel prior to the initiation of the polymerization. Further additions of chain transfer agent in a continuous or semi-continuous way during the polymerization may also be carried out. For example, a fluoropolymer having a bimodal molecular weight distribution is conveniently prepared by first polymerizing fluorinated monomer in the presence of an initial amount of chain transfer agent and then adding at a later point in the polymerization further chain transfer agent together with additional monomer. Preferred chain transfer agents include dimethyl ether (DME) and methyl t-butyl ether (MTBE) such as disclosed in U.S. Pat. No. 6,750,304. Other potential chain transfer agents include n-pentane and diethyl malonate.

The polymerization is usually initiated after an initial charge of monomer by adding an initiator or initiator system to the aqueous phase. Preferred initiators are ammonium-, alkali- or earth alkali salts of permanganic or manganic acid or manganic acids. The amount of initiator employed is typically between 0.03 and 2% by weight, preferably between 0.05 and 1% by weight based on the total weight of the polymerization mixture. The full amount of initiator may be added at the start of the polymerization or the initiator can be added to the polymerization in a continuous way during the polymerization until a conversion of 70 to 80%. One can also add part of the initiator at the start and the remainder in one or separate additional portions during the polymerization.

During the initiation of the polymerization reaction, the sealed reactor vessel and its contents are pre-heated to the reaction temperature. Preferred polymerization temperatures are from 30° C. to 80° C. and the pressure is typically between 4 and 30 bar, in particular between 8 and 20 bar.

The aqueous emulsion polymerization system may further comprise auxiliaries, such as buffers and complex-formers.

The amount of polymer solids that can be obtained at the end of the polymerization is typically between 10% and 45% by weight, preferably between 20% and 40% by weight and the average particle size of the resulting fluoropolymer is typically between 50 nm and 500 nm.

In accordance with the present invention, the resulting fluoropolymer has carboxylic or carboxylate end groups. The noted end groups can adversely affect the thermal stability of the polymer upon final work up. Therefore, a potassium salt is formed with either carboxylic or carboxylate end groups through ion exchange. This process step also effectively removes a significant portion of manganese ions.

In alternative embodiment, other divalent ions (e.g., Be⁺², Mg⁺², Ca⁺², etc.) may be subsequently exchanged with at least some of the potassium. The purpose for this may be related to desired physical characteristics in the polymer, such as color or other aesthetic features.

Ion exchange in accordance with the present invention can be accomplished through either fixed bed exchange resins or non-fixed bed exchange resins. The term “non-fixed resin bed” is used as the opposite of “fixed resin bed” where the cation exchange resin is not agitated. Fixed resin bed typically covers the so-called column technology in which the resin rests and removal of a substance occurs through a chromatographic process. Thus, in the present invention, the term non-fixed resin bed is used to indicate that the cation exchange resin is agitated such as for example being fluidized, stirred or shaken. Non-fixed resin bed technology is described in Ullmann Encyclopedia of Industrial Chemistry 5th Edition, Vol. A 14, p 439 ff. and in “Ion Exchangers” ed. Konrad Dorfner, Walter De Gruyter, Berlin, New York, 1991 p. 694 ff. These publications also describe fixed resin bed technology which is apparently used in the large majority of applications. Those of ordinary skill in the art are capable of selecting a desired style of exchange resin based upon the specific polymer, processing equipment, and processing conditions. Preferably, the aqueous fluoropolymer dispersion may be contacted with the cation exchange resin in a fixed bed configuration.

Fixed bed ion exchangers are conventional vessels possessing the fixed resin bed. Typically the vessels include packed columns. Those of ordinary skill in the art are capable of selecting a suitable resin for the packed column to achieve the desired level of ion exchange. Types of resins suitable for the present invention are detailed below. General operating conditions for the washing and generation of the resin into specific forms, such as a potassium form, are generally known.

According to one embodiment, the fluoropolymer dispersion is contacted with the cation exchange resin by agitating the mixture of fluoropolymer dispersion and cation exchange resin. Ways to agitate include shaking a vessel containing the mixture, stirring the mixture in a vessel with a stirrer or rotating the vessel around its axle. The rotation around the axel may be complete or partial and may include alternating the direction of rotation. Rotation of the vessel is generally a convenient way to cause the agitation. When rotation is used, baffles may be included in the vessel. A further attractive alternative to cause agitation of the mixture of exchange resin and fluoropolymer dispersion is fluidizing the exchange resin. Fluidization may be caused by flowing the dispersion through the exchange resin in a vessel whereby the flow of the dispersion causes the exchange resin to swirl. The conditions of agitation are generally selected such that on the one hand, the cation exchange resin is fully contacted with the dispersion, that is the cation exchange resin is completely immersed in the dispersion, and on the other hand the agitation conditions will be sufficiently mild so as to avoid damaging the cation exchange resin and/or causing coagulation of the fluoropolymer dispersion.

Cation exchange resins suitable for use in the present invention include polymers (typically cross-linked) that have a plurality of pendant anionic or acidic groups such as, for example, polysulfonates or polysulfonic acids, polycarboxylates or polycarboxylic acids. Sulfonic acid cation exchange resins contemplated for use in the practice of the invention include, for example, sulfonated styrene-divinylbenzene copolymers, sulfonated crosslinked styrene polymers, phenol-formaldehyde-sulfonic acid resins, and benzene-formaldehyde-sulfonic acid resins. Carboxylic acid cation exchange resins are suitable for use with the present invention.

Cation exchange resins are available commercially. Examples of suitable commercially available cation exchange resins include: resins having the trade designations “AMBERJET 1200”, “AMBERLITE IR-120”, “AMBERLITE IR-122”, or “AMBERLITE 132 E” available from Rohm and Haas Company, Philadelphia, Pa.; resins having the trade designations “DIAION SK 1B” and “DIAION SK 110” available from Mitsubishi Chemical, Tokyo, Japan; resins having the trade designations “DOWEX HCR-W2”, “DOWEX HCR-S”, and “DOWEX 650C”, available from Dow Chemical Company, Midland, Mich.; resins having the trade designations “IONAC C-249”, “IONAC C-253”, “IONAC C-266”, and “IONAC C-267”; and resins having the trade designations “LEWATIT S 100”, “LEWATIT S 100H” (acid form), “LEWATIT S 110”, “LEWATIT S110 H” (acid form), “LEWATIT S 1468”, “LEWATIT MONOPLUS SP 112”, “LEWATIT MONOPLUS SP 112” (acid form), “LEWATIT S 2568”, and “LEWATIT S 2568H” (acid form), all available from Sybron Chemicals, Inc., Birmingham, N.J.; and resins having the trade designations “PUROLITE C100”, “PUROLITE C100E”, “PUROLITE C100×10”, “PUROLITE C150TLH” and “PUROLITE C120E” available from The Purolite Co., Philadelphia, Pa. It is expected that other products of the same type would be equally satisfactory. Cation exchange resins such as those described above are commonly supplied commercially in either their acid or their sodium form. If the cation exchange resin is not in the acid form (i.e., protonated form) it should be at least partially converted, typically fully converted, to the acid form in order to avoid the generally undesired introduction of other cations into the sample. This conversion to the acid form may be accomplished by means well known in the art, for example by treatment with any adequately strong acid. Macroporous polystyrene sulfonate cation exchange resins are most preferred.

The aqueous emulsion polymerization process of the present invention comprises the polymerization of at least one partially fluorinated monomer. According to a particular embodiment of the present invention, the aqueous emulsion polymerization involves a copolymerization of a gaseous fluorinated monomer such as tetrafluoroethylene (TFE), chlorotrifluoroethylene (CTFE), and vinylidene fluoride (VDF) and a comonomer selected from the group consisting of vinylidene fluoride, perfluoroalkyl vinyl monomers, ethylene (E), propylene, fluorinated allyl ethers, in particular perfluorinated allyl ethers and fluorinated vinyl ethers, in particular perfluorovinyl ethers. Additional fluorinated and non-fluorinated monomers can be included as well. It will be understood by one skilled in the art that when the polymerization involves vinylidene fluoride, the gaseous fluorinated monomer would generally be either tetrafluoroethylene or chlorotrifluoroethylene or a comonomer other than vinylidene fluoride would have to be selected to obtain a copolymer. Examples of perfluoro alkyl vinyl ethers that can be used in the process of the invention include those that correspond to the formula:

CF₂=CF—O—R_{f}

wherein R_{f} represents a perfluorinated aliphatic group that may contain one or more oxygen atoms.

Particularly preferred perfluorinated vinyl ethers or perfluorinated alkoxy vinyl ethers correspond to the formula:

CF₂=CFO(R^{a}_{f}O)ₙ (R^{b}_{f}O)ₘR^{c}_{f}

wherein R^{a}_{f} and R^{b}_{f} are different linear or branched perfluoroalkylene groups of 1 to 6 carbon atoms, in particular 2 to 6 carbon atoms, m and n are independently 0 to 10 and R^{c}_{f} is a perfluoroalkyl group of 1 to 6 carbon atoms. Specific examples of perfluorinated vinyl ethers include perfluoro methyl vinyl ether (PMVE), perfluoro n-propyl vinyl ether (PPVE-1), perfluoro-2-propoxypropylvinyl ether (PPVE-2), perfluoro-3-methoxy-n-polyvinyl ether, perfluoro-2-methoxy-ethylvinyl ether and CF₃—(CF₂)₂—O—CF(CF₃)—CF₂—O—CF(CF₃)—CF₂—O—CF=CF₂.

Suitable perfluoroalkyl vinyl monomers correspond to the general formula:

CF₂=CF—R^{d}_{f} or CH₂=CH—R^{d}_{f}

wherein R^{d}_{f} represents a perfluoroalkyl group of 1 to 10, preferably 1 to 5 carbon atoms. A typical example of a perfluoroalkyl vinyl monomer is hexafluoropropylene.

The process of the present invention is preferably used for producing fluoropolymers that have a partially fluorinated backbone, i.e. part of the hydrogen atoms on the backbone are replaced with fluorine. Accordingly, the aqueous polymerization process of the present invention will generally involve at least one monomer that has an ethylenically unsaturated group that is partially fluorinated (e.g. vinylidene fluoride) or not fluorinated (e.g. ethylene or propylene).

Examples of fluoropolymers that are preferably produced with the process of the invention include a copolymer of vinylidene fluoride and hexafluoropropylene; a copolymer of tetrafluoroethylene and vinylidene fluoride; a copolymer of chlorotrifluoroethylene and vinylidene fluoride; a copolymer of tetrafluoroethylene and ethylene; a copolymer of tetrafluoroethylene and propylene; a copolymer of vinylidene fluoride and perfluorovinyl ether (e.g. PMVE, PPVE-1, PPVE-2 or a combination of PPVE-1 and PPVE-2); a polymer of tetrafluoroethylene, perfluorovinyl ether (e.g. PMVE, PPVE-1, PPVE-2 or a combination of PPVE-1 and PPVE-2), and ethylene or propylene; a polymer of tetrafluoroethylene, hexafluoropropylene, and ethylene or propylene; a polymer of tetrafluoroethylene, vinylidene fluoride and hexafluoropropylene; a polymer of vinylidene fluoride, tetrafluoroethylene, and perfluorovinyl ether (e.g. PMVE, PPVE-1, PPVE-2 or a combination of PPVE-1 and PPVE-2); and a polymer of tetrafluoroethylene, hexafluoropropylene, perfluorovinyl ether (e.g. PMVE, PPVE-1, PPVE-2 or a combination of PPVE-1 and PPVE-2), and ethylene or propylene.

The fluoropolymers that can be produced with the process of the invention are generally semi-crystalline fluoropolymers. Fluorothermoplastics are polymers that generally have a pronounced melting peak and that generally have crystallinity. The fluorothermoplastics according to this invention will generally be melt processible, i.e. they will typically have a melt flow index of at least 0.1 g/10 min as measured with a load of 5 kg and at a temperature of 265° C. as set out in the examples below.

Fluorothermoplastics that can be produced with the process of the present invention generally will have a melting point between 50° C. and 300° C., preferably between 60° C. and 280° C. Particularly desirable fluorothermoplastics that can be produced with the process of this invention include for example copolymers of E and TFE, copolymers of TFE and VDF, copolymers of VDF and HFP (hexafluoropropylene), copolymers of CTFE and VDF, polymers of TFE, E and HFP and polymers of TFE, HFP and VDF.

The resulting dispersions from the aqueous emulsion polymerization process of the present invention can be subjected to subsequent processing steps to generate granular or powder fluoropolymer compounds. The additional processing steps may include agglomerating, washing, filtering, drying, and combinations thereof. Additionally, the agglomerated form may subsequently be milled to provide powder compositions. Those of ordinary skill in the art are capable of selecting processing steps and conditions for selected partially fluorinated polymers to achieve the desired end form.

Other conventional additives may be added to the composition. Non-limiting examples include pigments, flow agents, and binders. Conventional thermal stabilizers, such as those based upon heavy metals powders, oxides, nitrates, halides, or complexes thereof, may also be post added to the partially fluorinated polymer. Other conventional thermal stabilizers may also be included. Non-limiting examples of other thermal stabilizers include antioxidants and free radical scavengers.

The resulting polymer generally has a melt flow index (MFI) value between 1 and 50. The MFI value may either increase or decrease when subjected to a thermal stability test in air at 300° C. for 90 minutes. In accordance with the present invention, the polymer exhibits a change in MFI value of less than 40%, less than 30%, less than 20% or less than 10% when subjected to a thermal stability test in air at 300° C. for 90 minutes. In MFI testing, the effect of thermal degradation may be offset by crosslinking of the polymer leading to only a small change in the measured MFI. Therefore, the appearance of the MFI extrudate must also be evaluated. For example, visible chunks in the MFI strand are an indication of possible crosslinking of the polymer during thermal aging and a sign of thermal instability. Brittle MFI strands are likely to have undergone degradation during thermal aging. Strands which are smooth, of uniform diameter, and remain flexible after oven aging indicate the polymer is thermally stable during the thermal stability test.

The resulting polymer may have manganese levels of less than 1 ppm (parts per million), less than 0.8 ppm, less than 0.5 ppm, or even less than 0.2 ppm. The resulting polymer may have potassium levels greater than 10 ppm, greater than 20 ppm, greater than 50 ppm, greater than 100 ppm, or even greater than 150 ppm.

For purposes of the invention, the thermal stability is measured solely on the polymer in the absence of thermal stabilizers at the noted temperature and time condition. Potassium ions are not considered a thermal stabilizer under this test.

The inventive composition may be applied to an article via any known method. Such methods include, for example, coating as an aqueous dispersion, applying as a powder, laminating, and combinations thereof.

In a preferred embodiment, powder coating formulations are used to apply the partially fluorinated polymer onto a substrate to form and article. The powder is applied by conventional powder coating techniques. Non-limiting examples of powder coating techniques include electrostatic spray coating and fluidized bed coating. Electrostatic powder spray coating is preferred. Those skilled in the art are capable of selecting appropriate coating techniques to achieve desired results.

After application by powder coating, further processing by heat at a temperature above the melt temperature of the fluoropolymer is used to fuse and coalesce the powder particles into a coating. Selection of a specific time and temperature to fuse and coalesce the powder particles will depend upon the selected fluoropolymer, the selected substrate and the applied coating thickness. Those skilled in the art are capable of determining the appropriate temperatures and times.

The invention will now be further illustrated with reference to the following examples without the intention to limit the invention thereto. All parts and percentages are by weight unless indicated otherwise.

### EXAMPLES

### Melt Flow Index

The MFI was carried out according to DIN 53735, ISO 12086 or ASTM D-1238 at a support weight of 5.0 kg and a temperature of 265° C. The MFI's cited here were obtained with a standardized extrusion die of 2.1 mm diameter and a length of 8.0 mm.

### Oven Aging

The thermal stability test was carried out using 20 g of the agglomerate and baking it in an air circulating oven at 300° C. for 90 minutes on a PTFE (polytetrafluoroethylene) sheet. The material was evaluated for color, foaming, and embrittlement by manually flexing back and forth. The oven-aged material was then cut up for MFI testing. The MFI extrudate was also evaluated for appearance and embrittlement by manually flexing the strand back and forth.

### Atomic Absorption

An Atomic Absorption Spectrometer model 3300/HGA-60 with Autosampler AS-60 was used. Samples were either analyzed as neat aqueous dispersion or diluted with high purified water to bring the manganese or potassium levels within the calibration range. Standards were stock solutions of 1000 ppm manganese or potassium, purchased from Perkin Elmer, Waltham, Mass. Working standards were 0, 0.1, 0.5, and 1 ppm manganese or potassium (20 μL injection) diluted from 1000 ppm stock solutions. The instrument conditions for manganese were the following: Wavelength=403.1 nm; Slit Width=0.2; Read Time=5 sec; Read Delay=0.0 sec; BOC Time=2 sec; Signal Type=Atomic Absorption; Measure=Peak Area.

Furnace Conditions for manganese:

| | Temperature | Ramp Time | | |
|---|---|---|---|---|
| Step# | (° C.) | (sec) | Hold Time (sec) | Internal Flow |
| 1 | 180 | 10 | 30 | 300 |
| 2 | 1500 | 5 | 30 | 300 |
| 3 | 20 | 1 | 10 | 300 |
| 4 | 2200 | 0 | 5 | 0 (read) |
| 5 | 2600 | 1 | 5 | 300 |

ETFE Polymerization with PFOA

A polymerization vessel with a total volume of 52 L equipped with an impeller agitator system was charged with 29 L deionized water, 10.5 g oxalic acid, 13.1 g ammonium oxalate and 514 g perfluorooctanoate ammonium (PFOA) salt solution (30% solution). The oxygen free vessel was then heated up to 45° C. and the agitation system was set to 230 rpm. The vessel was charged with 76 g dimethyl ether and 240 g PPVE-1, then charged with HFP until the pressure was raised by 1.19 bar, then charged with E until the pressure was raised by 2.55 bar, and then charged with TFE until the pressure was raised to 17.4 bar absolute reaction pressure. The polymerization was initiated by 90 g of a 2.7% aqueous potassium permanganate solution. As the reaction started, the reaction pressure of 17.4 bar absolute was maintained by feeding TFE, E, HFP, and PPVE-1 into the gas phase with the following feeding ratios (kg/kg): E/TFE of 0.241, PPVE-1/TFE of 0.051, and HFP/TFE of 0.052. Within the polymerization, the 2.7% aqueous potassium permanganate solution continuously was charged into the vessel with a feeding rate of 90 g/hr. A reaction temperature of 45° C. was maintained.

After feeding 9.4 kg TFE, the monomer feed was interrupted and the monomer valves were closed. The addition of potassium permanganate solution was maintained at a feed rate of 25 g/hr. Within 15 min, the monomer gas phase was reacted down to a vessel pressure of 9.2 bar.

The thus obtained 43.8 kg aqueous dispersion with a solids content of 31% consisted of latex particles having 67 nm diameter according to dynamic light scattering.

ETFE Polymerization without PFOA

A polymerization vessel with a total volume of 52 L equipped with an impeller agitator system was charged with 29 L deionized water, 10.5 g oxalic acid, 13.1 g ammonium oxalate and 470 g 3H-Perfluor-4,8-dioxanonanoicacid ammonium salt solution (30%). The oxygen free vessel was then heated up to 45° C. and the agitation system was set to 230 rpm. The vessel was charged with 76 g dimethyl ether and 240 g PPVE-1, then charged with HFP until the pressure was raised by 1.19 bar, then charged with E until the pressure was raised by 2.55 bar, and then charged with TFE until the pressure was raised to 17.4 bar absolute reaction pressure. The polymerization was initiated by 100 g of a 2.7% aqueous potassium permanganate solution. As the reaction started, the reaction pressure of 17.4 bar absolute was maintained by feeding TFE, E, HFP and PPVE-1 into the gas phase with a feeding ratio E (kg)/TFE (kg) of 0.241, PPVE-1 (kg)/TFE (kg) of 0.051 and HFP (kg)/TFE (kg) of 0.052. Within the polymerization, the 2.7% aqueous potassium permanganate solution continuously was charged into the vessel with a feeding rate 90 g/hr. A reaction temperature of 45° C. was maintained.

After feeding 9.4 kg TFE, the monomer feed was interrupted and the monomer valves were closed. The addition of potassium permanganate solution was maintained at a feed rate of 25 g/h. Within 15 min, the monomer gas phase was reacted down to a vessel pressure of 9.2 bar.

The thus obtained 43.8 kg aqueous dispersion with a solids content of 31% consisted of latex particles having 67 nm diameter according to dynamic light scattering.

In the examples below, all aqueous solutions, dispersions and rinses are made with deionized water.

### EXAMPLE 1

An aqueous dispersion of modified ETFE (ethylene/tetrafluoroethylene/hexafluoropropylene/perfluoropropylvinyl ether) in the molar ratios 45/52/2/1 was prepared by emulsion polymerization using the method described under “ETFE Polymerization with PFOA”.

The potassium ion exchange bed was prepared by adding 100 mL of PUROLITE C150TLH strong acid cation exchange resin (The Purolite Co.) to a chromatography column equipped with a PTFE stopcock. The bottom of the column was plugged with a small amount of glass wool. The resin was rinsed with 2 L of water at 8 bed volumes/hr (BV/hr) followed by an additional 2 L of water at 4 BV/hr. Then 1.2 L of aqueous 5% KCl solution was passed through the column at 5 to 6 BV/hr. The resin bed was again rinsed with 200 mL of water at 2 BV/hr followed by 800 mL of water with the stopcock completely open.

Then 1250 mL of the aqueous dispersion was passed through the potassium ion exchange column at 4 BV/hr and collected in five 250 mL increments. A total of 12.5 bedvolumes of aqueous dispersion was ion exchanged.

To work up the material, the five increments of potassium ion-exchanged aqueous dispersion were placed in a freezer overnight or until the latex was frozen solid. Each of the five 250 mL increments were treated as follows. After complete thawing, 75 mL of n-heptane was added to the increment and stirred for 15 min. The liquid was filtered off leaving an agglomerate. The agglomerate was washed as follows: 125 mL of water was added to the agglomerate and stirred for 10 min, then filtered. The water wash was repeated two more times followed by a final filtering to obtain the agglomerate.

A small amount of the agglomerate was dried at 120° C. for 2 hrs. The MFI on the agglomerate with no Oven Aging was measured to be 5.9. The MFI extrudate of the agglomerate with no Oven Aging was translucent, smooth and flexible.

The agglomerate then was oven-aged following the Oven Aging procedure above and the appearance noted. The oven-aged agglomerate was then cut up for MFI testing. The average MFI of the five oven-aged samples was 5.8, and the MFI extrudate was evaluated for color, smoothness, and flexibility. The results are shown in Table 1

### EXAMPLE 2

The aqueous dispersion from the same polymerization as Example 1 was used in Example 2. Example 2 was prepared similarly to Example 1 except for the following. The ion exchange resin was washed with only 2 L of water at 8 BV/hr, instead of the 2 L of water at 8 BV/hr followed by an additional 2 L of water at 4 BV/hr. The ion-exchanged aqueous dispersion was collected in 250 mL increments, however, in Example 2, only the first 250 mL increment was coagulated. The 250 mL increment was coagulated using 2.5 mL of aqueous 37% HCl instead of freezing. The aqueous dispersion was subsequently agglomerated, washed, and filtered as described in Example 1.

The agglomerate then was oven-aged following the Oven Aging procedure above and the MFI tested. The results are shown in Table 1.

### EXAMPLE 3

The second 250 mL increment of ion-exchanged aqueous dispersion collected in Example 2 was coagulated using 2.5 mL of 37% HCl as in Example 2, however a different agglomerate washing procedure was used. 125 mL of water with 2.5 mL of 37% HCl was added to the agglomerate and stirred for 10 min, then filtered. The wash was repeated three more times using 125 mL of water followed by a final filtering to obtain the agglomerate.

The agglomerate then was oven-aged following the Oven Aging procedure above and the MFI tested. The results are shown in Table 1.

### EXAMPLE 4

The aqueous dispersion from the same polymerization as Example 1 was used in Example 4. In this example, 500 mL of previously used PUROLITE C15OTLH resin was added to a 1 L chromatography column equipped with a PTFE stopcock. The resin was rinsed with 2 L of water at 8 BV/hr. Then 2 L of 5% HCl solution was passed through at 4 BV/hr followed by 5 L of water with the stopcock fully open. Then 100 mL of this resin was placed in a smaller chromatography column and regenerated to the potassium ion form by passing 1.6 L of aqueous 5% KCl solution at 6 BV/hr. The resin bed was rinsed with 200 mL of water at 2 BV/hr followed by 800 mL of water at 6BV/hr.

A total of 6300 mL of the aqueous dispersion was cation exchanged at 2 to 3 BV/hr. The last 1200 mL of the ion-exchanged aqueous dispersion through the column was collected and divided into two. From 600 mL of the ion-exchanged aqeous dispersion, a small sample was analyzed using atomic absorption, which detected total manganese concentration at 0.06 ppm.

The other 600 mL of the ion-exchanged aqueous dispersion was frozen solid. 180 mL of n-heptane was added to the thawed aqueous dispersion and stirred for 15 min. The liquid was filtered off leaving an agglomerate. 300 mL of water was added to the agglomerate and stirred for 10 min, then filtered. The water wash was repeated two more times followed by a final filtering to obtain the agglomerate.

The agglomerate then was oven-aged following the Oven Aging procedure above and the MFI tested. The results are shown in Table 1.

### EXAMPLE 5

An aqueous dispersion of modified ETFE was prepared using the method described under “ETFE Polymerization with PFOA”. The aqueous dispersion was potassium ion exchanged as in Example 1. A sample of the potassium ion-exchanged dispersion was submitted for atomic absorption analysis. The potassium ion-exchanged aqueous dispersion indicated 0.14 ppm manganese and 152 ppm potassium.

A calcium ion exchange column was prepared as follows: 100 mL of new PUROLITE C150TLH was loaded into a chromatography column with a PTFE stopcock. The bottom of the column was plugged with a small amount of glass wool and the resin was rinsed with 2 L of water with the stopcock fully open. Then 1 L of aqueous 5% CaCl₂ solution was passed through at 4 BV/hr. The resin bed was again rinsed with 200 mL of water at 4 BV/hr followed by 2800 mL with the stopcock completely open.

Then 250 mL of aqueous dispersion was passed through the column at 2 BV/hr and the calcium ion-exchanged aqueous dispersion was collected.

A sample of the calcium ion-exchanged aqueous dispersion was submitted for atomic absorption analysis. The calcium ion-exchanged aqueous dispersion indicated <0.1 ppm manganese and 22 ppm potassium.

The calcium ion-exchanged aqueous dispersion was frozen overnight. After complete thawing, 75 mL n-heptane was added and stirred for 15 min. The liquid was filtered off leaving an agglomerate. 125 mL of water was added to the agglomerate stirred for 10 min, then filtered. The water wash was repeated two more times followed by a final filtering to obtain the agglomerate.

A small amount of the agglomerate was dried at 120° C. for 2 hrs. The MFI on the latex with no Oven Aging was measured to be 4.8.

The agglomerate then was oven-aged following the Oven Aging procedure above and the MFI tested. The results are shown in Table 1.

TABLE 1

| | Example | | | | |
|---|---|---|---|---|---|
| | 1 | 2 | 3 | 4 | 5 |
| Appearance after | Translucent, | Translucent, | Translucent, | Translucent, | Translucent, |
| oven aging at | brown, fine | light | light | brown, fine | dark brown, |
| 300° C. for 90 min | bubbles, | brown, fine | brown, fine | bubbles, | flexible and |
| | flexible | bubbles, | bubbles, | flexible | contained |
| | | flexible | flexible | | fine bubbles |
| MFI after oven | 5.8 | 5.5 | 5.5 | 5.7 | 3.0 |
| aging at 300° C. | | | | | |
| for 90 min | | | | | |
| MFI strand | Brown, | Light tan, | Light tan, | Brown, | Dark brown, |
| appearance | smooth, | slightly | slightly | smooth, | smooth and |
| | flexible | rough, | rough, | flexible | flexible. |
| | | flexible | flexible | | |

### EXAMPLE 6

An aqueous dispersion of modified ETFE was prepared using the method described under “ETFE Polymerization without PFOA”.

In this example, 100 mL of previously used PUROLITE C150TLH resin was added to the chromatography column equipped with a PTFE stopcock. The resin was rinsed with 2 L of water at 8 BV/hr. Then 2 L of aqueous 5% HCl solution was passed through at 4 BV/hr followed by 5 L of water with the stopcock fully open. Then the column was regenerated to the potassium ion form by passing about 2 L of aqueous 5% KCl at 5 to 6 BV/hr. The resin bed was rinsed with 200 mL of water at 2 BV/hr followed by 800 mL of water with the stopcock completely open.

A total of 1 L of the aqueous dispersion was cation exchanged at 4 BV/hr. The ion-exchanged aqueous dispersion was collected. A small sample was analyzed using atomic absorption, which detected total manganese concentration at 0.8 ppm.

The remainder of the ion-exchanged aqueous dispersion was frozen solid. 300 mL of n-heptane was added to the thawed aqueous dispersion and stirred for 15 min. The liquid was filtered off leaving an agglomerate. 500 mL water was added to the agglomerate and stirred for 10 min, then filtered. The water wash was repeated two more times followed by a final filtering to obtain the agglomerate.

A small amount of the agglomerate was dried at 120° C. for 2 hrs. The MFI on the latex with no Oven Aging was measured to be 9.8.

The agglomerate then was oven-aged following the Oven Aging procedure above and the MFI tested. The results are shown in Table 2.

TABLE 2

| | Example |
|---|---|
| | 6 |
| Appearance | Translucent, |
| after oven aging | brown, fine |
| at 300° C. for 90 min | bubbles, |
| | flexible |
| MFI after oven | 8.7 |
| aging at 300° C. | |
| for 90 min | |
| MFI strand | Brown, |
| appearance | smooth, |
| | flexible |

### COMPARATIVE EXAMPLE 1

The aqueous latex dispersion from the same polymerization as Example 1 was used in Comparative Example 1 (C1).

A proton exchange bed was prepared by adding 300 g of PUROLITE C150TLH cation exchange resin to a chromatography column equipped with a PTFE stopcock. The bottom of the column was plugged with a small amount of glass wool. The resin was used as received and rinsed with 7 L of water with the stopcock completely open.

Then the aqueous dispersion was passed through the column at 3.3 BV/hr and the proton-exchanged aqueous dispersion was collected.

To work up the material, 500 mL of the proton-exchanged aquoeus dispersion was frozen solid. After complete thawing, 150 mL of n-heptane was added to the proton-exchanged aqueous dispersion and stirred. The liquid was filtered off, leaving an agglomerate. 250 mL of water was added to the agglomerate and stirred, then filtered. The water wash was repeated two more times followed by a final filtering to obtain the agglomerate.

The agglomerate then was oven-aged following the Oven Aging procedure above and the MFI tested. The results are summarized in Table 3.

### COMPARATIVE EXAMPLE 2

The aqueous dispersion from the same polymerization as Example 1 was used in Comparative Example 2 (C2). C2 was made similarly to Example 1 except for the following. The ion exchange resin was washed with only 2 L of water at 8 BV/hr, instead of the 2 L of water at 8 BV/hr followed by an additional 2 L of water at 4 BV/hr. Then, instead of using a solution of KCl, 1 L of aqueous 5% NH₄Cl solution was passed through the column at 6 BV/hr.

Then the aqueous dispersion was passed through the ammonium ion exchange column and collected in five 250 mL increments. The fifth 250 mL increment of ammonium ion-exchanged aqueous dispersion was agglomerated, washed, and filtered as in Example 1. The agglomerate then was oven-aged following the Oven Aging procedure above and the MFI after oven aging was tested. The results are shown in Table 3.

### COMPARATIVE EXAMPLE 3

The aqueous dispersion from the same polymerization as Example 1 was used in Comparative Example 3 (C3). C3 was made similar to Example 1 except for the following. Instead of using a solution of KCl, 1.2 L of aqueous 5% NaCl solution was passed through the column.

Then the aqueous dispersion was passed through the sodium ion-exchange column and collected. The sodium ion-exchanged aqueous dispersion was agglomerated, washed, and filtered as in Example 1. The agglomerate then was oven-aged following the Oven Aging procedure above and the MFI after oven aging was tested. The results are shown in Table 3.

### COMPARATIVE EXAMPLE 4

The aqueous dispersion from the same polymerization as Example 1 was used in Comparative Example 4 (C4). In C4, 100 mL of previously used PUROLITE C150TLH resin was added to the chromatography column equipped with glass wool and a PTFE stopcock. The resin was rinsed with 2 L of water with the stopcock completely open. To regenerate the resin to the acid form, 1 L of aqueous 10% HCl solution was passed through at 6 BV/hr followed by 200 mL of water at 2 BV/hr and 1800 mL of water at 6 BV/hr. Then, 1 L of aqueous 5% CsCl solution was passed through the column at 6 BV/hr. A final rinse of the resin was completed with 2 L of water at 6 BV/hr.

500 mL of the aqueous dispersion was cation exchanged at 2 BV/hr and the cesium ion-exchanged aqueous dispersion was collected.

The 500 mL of the cesium ion-exchanged aqueous dispersion was frozen solid. After complete thawing, 150 mL of n-heptane was added and stirred for 15 min. The liquid was filtered off, leaving an agglomerate. 250 mL of water was added to the agglomerate, stirred 10 min, then filtered. The water wash was repeated four more times followed by a final filtering to obtain the agglomerate. The agglomerate then was oven-aged following the Oven Aging procedure above and the MFI after oven aging was tested. The results are shown in Table 3.

### COMPARATIVE EXAMPLE 5

The aqueous dispersion from the same polymerization as Example 1 was used in Comparative Example 5 (C5). C5 was made similar to C4 except instead of the CsCl solution, 1 L of aqueous 5% LiOH solution passed through the column to generate a lithium ion exchange resin. The lithium ion-exchanged aqueous dispersion was agglomerated, washed, and filtered as in C4. The agglomerate then was oven-aged following the Oven Aging procedure above and the MFI after oven aging was tested. The results are shown in Table 3.

TABLE 3

| | Example | | | | |
|---|---|---|---|---|---|
| | C1 | C2 | C3 | C4 | C5 |
| Appearance after | White and | Yellow, | Dark rust | Yellowish | Orangish |
| oven aging at | yellow areas, | large | colored, | brown, | brown, |
| 300° C. for 90 min | large bubbles | bubbles, | foamed, | foamed | foamed |
| | | brittle | brittle | | |
| MFI after oven | 39 | 136 | Not | 15.5 | 8.4 |
| aging at 300° C. | | | measurable | | |
| for 90 min | | | | | |
| MFI strand | Light | Yellow | Cross- | Yellowish | Brown, |
| appearance | yellow | with | linked plug | brown, | rough chunks |
| | | chunks | | rough | |
| | | | | chunks | |

### COMPARATIVE EXAMPLE 6

The aqueous dispersion from the same polymerization as Example 1 was used in Comparative Example (C6). C6 was made similarly to Example 4 with the following exceptions. After regenerating the resin to the acid form, 1.6 L of aqueous 5% KCl solution was used to regenerate 100 mL of the resin at 6 BV/hr. 1 L of the aqueous dispersion was ion exchanged through the potassium-form resin at 2 BV/hr.

A second column was prepared similarly to the first column, except 1 L of 5% NH₄Cl solution was used to convert the resin to the ammonium form at 6 BV/hr. 1 L of the potassium ion-exchanged aqueous dispersion was re-ion exchanged through the ammonium-form resin at 3 BV/hr.

Atomic absorption analysis indicated the potassium concentration in the aqueous dispersion dropped from 620 ppm to 0.05 ppm after re-ion exchanging the aqueous dispersion through the ammonium-form resin.

The last 250 mL of ammonium ion-exchanged aqueous dispersion was frozen solid, then worked up as in Example 1. The agglomerate then was oven-aged following the Oven Aging procedure above and the MFI was tested. The results are shown in Table 4.

### COMPARATIVE EXAMPLE 7

The aqueous dispersion from the same polymerization as Example 1 was used in Comparative Example 7 (C7). C7 was made similarly to Example 4 with the following exceptions. After regenerating the resin to the acid form, 1.2 L of aqueous 5% KCl solution was used at 6 BV/hr to regenerate 100 mL of the resin to the potassium form. The resin was rinsed with 200 mL water at 2 BV/hr and an additional 800 mL of water with the stopcock completely open. 20 mL of aqueous 20% acetic acid solution was added to 1 L of the aqueous dispersion. The aqueous dispersion was ion exchanged at 4 BV/hr and the second 500 mL through the column was collected. Atomic absorption analysis of this ion-exchanged aqueous dispersion indicated the manganese concentration at 0.07 ppm and the potassium concentration at 774 ppm.

250 mL of this ion-exchanged aqueous dispersion was re-ion exchanged through 100 mL of resin regenerated into the proton-form as in Example 4. Atomic absorption analysis indicated the potassium concentration in the ion-exchanged aqueous dispersion had decreased to 0.68 ppm. The ion-exchanged aqueous dispersion was frozen solid, then worked up as in Example 1. The agglomerate then was oven-aged following the Oven Aging procedure above and the MFI tested. The results are shown in Table 4.

TABLE 4

| | Example | |
|---|---|---|
| | C6 | C7 |
| Appearance after | Ivory, large bubbles | Light yellow, large |
| oven aging at | | bubbles, brittle |
| 300° C. for 90 min | | |
| MFI after oven | 119 | 99 |
| aging at 300° C. for | | |
| 90 min | | |
| MFI strand | Yellow with | Light yellow and |
| appearance | chunks | foamed |

1. A method comprising,
(a) providing a partially fluorinated polymer through an emulsion polymerization process, wherein the partially fluorinated polymer has carboxylic or carboxylate end groups, and
(b) forming a potassium salt with either the carboxylic or carboxylate end groups through ion exchange.

2. A method according to claim 1, wherein the resulting polymer exhibits a change in an MFI value of less than 40% when subjected to a thermal stability test in air at 300° C. for 90 minutes.

3. A method according to claim 1, wherein the resulting polymer contains manganese levels less than 1 ppm.

4. A method according to claim 1, further comprising additional steps selected from one or more of agglomerating, washing, filtering, and drying.

5. (canceled)

6. A method according to claim 1, wherein the resulting polymer has potassium levels greater than 10 ppm.

7. A method according to claim 1, wherein the partially fluorinated polymer comprises a polymer of ethylene and tetrafluoroethylene and optionally other monomers.

8. A method according to claim 1, wherein the emulsion polymerization process uses potassium permanganate as an initiator.

9. A method according to claim 1, wherein the emulsion polymerization process uses dimethyl ether as a chain transfer agent.

10. A method according to claim 1, wherein no heavy metal compounds as thermal stabilizers are post added to the partially fluorinated polymer.

11. A method according to claim 1, further comprising adding heavy metals compounds as thermal stabilizers.

12. A method according to claim 1, wherein the fluoropolymer is provided in powder form.

13. A method according to claim 12, further comprising pigments, flow agents, binders, or combinations thereof.

14. A method according to claim 1, further comprising a fluorinated surfactant including at least one of the following: CF₃O(CF₂)₃OCHFCF₂COONH₄ and CF₃O(CF₂)₃OCF₂COONH₄.

15. A method according to claim 1, wherein a potassium ion within the potassium salt is subsequently exchanged with a divalent cation.

16. A method comprising applying a powder form of the composition resulting from the method of claim 1 onto a substrate and then forming at least a partial layer from the powder.

17. A composition comprising a fluorinated polymer derived from at least one partially fluorinated or a non-fluorinated monomer, wherein the fluorinated polymer exhibits a change in an MFI value of less than 40% when subjected to a thermal stability test in air at 300° C. for 90 minutes, and wherein the fluorinated polymer further comprises potassium ions.

18-19. (canceled)

20. A composition according to claim 17, wherein the fluorinated polymer has an MFI value between 1 and 50.

21. A composition according to claim 17, wherein the fluorinated polymer is in a powder form.

22. (canceled)

23. An article comprising a polymeric layer applied to a substrate wherein the polymeric layer comprises the fluorinated polymer of claim 17.

24. The article according to claim 23, wherein the article is a powder coated article.
